(19) United States
(12) Patent Application Publication
(10) Pub. No.: US 2003/0190919 A1
(43) Pub. Date: Oct. 9, 2003

(54) Method for positioning a mobile station

(76) Inventor: Jarko Niemenmaa, Espoo (FI)

Correspondence Address: COHEN, PONTANI, LIEBERMAN & PAVANE, 551 FIFTH AVENUE, SUITE 1210, NEW YORK, NY, 10176, US

(21) Appl. No.: 10/362,086

(22) PCT Filed: Aug. 21, 2001
(86) PCT No.: PCT/FI01/00734

(30) Foreign Application Priority Data
Aug. 22, 2000 (FI) 20001852

(51) Int. Cl. H04H 1/00

(52) U.S. Cl. 455/456.1; 455/422.1; 455/435.1; 455/404.2; 455/3.02

(57) ABSTRACT

The invention provides a simple and efficient method for positioning a mobile station applying a principle based on signal propagation time differences so that the method uses in the radio signal propagation time measurement those base stations which either do not have functioning repeaters in their coverage areas or, if there are not enough such base stations, the base station delays will be compensated for. The method brings advantage in positioning accuracy compared to a prior-art method such as e.g. an OTD or E-OTD method.

The invention relates to mobile communication technology and is especially directed to the positioning of mobile stations in the manner specified in the characterizing part of claim 1.

One of the cornerstones of mobile communication technology is the determination of the position of a mobile station for call maintenance and billing purposes. Moreover, there are situations in which the user of a mobile station needs to determine his position coordinates either when orientating himself, having lost his way, having had an accident or because of an attack of illness or some other much more general reason, like in order to inquire the location of a service in a certain area, for example.

There are a plurality of ways to determine the position of a mobile station. A widely used method called the Global Positioning System (GPS) is based on signals received from satellites orbiting Earth. This method requires a GPS receiver which should be integrated in the mobile station and thus would result in additional costs. Since positioning is an essential part in the already existing functionality of a mobile station it is advantageous to use the cellular system's own radio signals transferred between the mobile station and base stations to determine the position of the mobile station, even though some mobile station models may include a GPS receiver, too.

The distance of a mobile station from a base station can be determined on the basis of the propagation delay of a signal transferred between the mobile station and the base station. By measuring the propagation delay of a signal transmitted to the mobile station from a base station it is obtained a distance estimate for the range between the mobile station and the base station. Because of a certain measuring accuracy associated with the distance measurement, the assumed position of the mobile station will be, in a system utilizing nondirectional antennas, an area confined by two circular borders where the width of the area depends on the accuracy of the time delay measurement. A corresponding propagation delay measurement may also be performed using a signal between the mobile station and other base stations in its coverage area. The result is then one ringlike location area as described above per each base station involved in the measurement. Thus, the mobile station can be positioned at the intersection of the location areas, the order of dimension of the intersection corresponding to the measuring accuracy. In the method described above the positioning is substantially carried out by the system, and no special functions are needed in mobile stations to perform the measurement.

A method is also known in which the positioning is based on signals transmitted from the mobile station or from certain base stations and on measuring the propagation times of those signals as well as processing the results in a substantially centralized manner. One such method is a positioning method used in the GSM system, based on the propagation time of a radio transmission and utilizing a concept called the time difference of arrival (TDOA), where a mobile station transmits a signal to at least three base transceiver stations (BTS) which measure the arrival times of the signals so that their time differences can be calculated. The time differences are obtained using the impulse response which is a result of correlation between a known bit pattern and a received burst signal. The bit pattern is a so-called training sequence or a corresponding known sequence. The training sequence is part of the structure of a transmission burst; in GSM, for example, it is placed in the middle of the burst. The time difference can be determined on the basis of the impulse response e.g. by selecting a point corresponding to the highest correlation or a point corresponding to the first arrived component. The impulse response refers in general to an output of an apparatus, for example, when a signal of a certain delta function type is fed into the input. The first arrived component refers to the signal that arrived via the shortest route in the case of multipath propagation and the impulse response peak caused by the signal at the point corresponding to the signal. The time differences are used in a location service center (LSC) to produce at least two hyperbolas describing the position of the mobile station so that the intersection of the hyperbolas indicates the position of the mobile station. Because of inaccuracies in the time differences the intersection of the hyperbolas define an area, not a singular point. Positions of the hyperbolas are determined by the positions of the base stations.

It is also known a measurement based on the time difference of received signals. One such method is a positioning method based on the propagation time of a radio transmission. The position is calculated in the mobile station or the measurement data (Observed Time Difference, OTD) are sent to the mobile communication network to calculate the position. In an OTD-based system utilizing the mobile communication network at least three base transceiver stations transmit a radio signal to a mobile station which calculates the observed time difference for the signals. The mobile station, too, transmits a radio signal to at least three base transceiver stations (BTS) which calculate the time difference of arrival (TDOA) for the signals. The time differences are used in a location service center (LSC) to produce at least two hyperbolas at the intersection of which the mobile station is positioned. Because of inaccuracies in the time differences the hyperbolas are stretched into wide bands the intersection of which define an area, not a singular point. Positions of the hyperbolas are determined with respect to the positions of the base stations.

An estimate for the position of the mobile station is determined by means of the observed time difference (OTD) between the signals received from the base transceiver stations, whereby it is possible to calculate by means of the time difference between signals received from two base transceiver stations the difference d1-d2 between the distance d1 between the mobile station and a first base transceiver station and the distance d2 between the mobile station and a second base transceiver station. Then those potential points of location of the mobile station in which the value of the distance difference equals d1-d2 constitute a hyperbola-shaped curve, which thus represents the potential points of location of the mobile station. Since the measurement result involves a certain margin of error, the location area of the mobile station is in reality an area between two hyperbolas, the width of the area depending on the error margin of the measurement result. When signals are received from at least three base transceiver stations, the result consists of a plurality of location areas, and the mobile station is located at the intersection of those areas. Determining a restricted location area requires time difference measurement for signals received from at least three base transceiver stations unless other methods such as propagation delay measurement are used in addition to the time difference measurement. If other additional methods are used, it is possible to use the time difference measured for signals received from only two base transceiver stations. As was mentioned earlier, this kind of positioning of a mobile station can be realized either in the mobile station or in the system.

It is important, especially for the accuracy of OTD-based positioning, that the radio signal propagates straightforward and through air, i.e. either in mediumless space or through air and/or a like medium. If there is a repeater station between the mobile station and base transceiver station, the radio signal appears to travel a longer distance than it does in reality. Since it is explicitly assumed that the signal travels at a certain speed characteristic to it, OTD-based positioning will suffer from the delay caused by the time required by the electronic circuitry in the repeater stations to process the signal passing theretluough—i.e. the time used in the electronic processing of the signal. Said time includes the combined times used by all the steps between the reception and transmission of the signal in the repeater, i.e. the air-to-air time. Hereinafter this delay will be referred to as the repeater station delay. A single OTD may in this case be very extraordinary. For example, the nearest two base transceiver stations used in the positioning may involve very different quantities of repeater stations which, additionally, have different degrees of load. It is then possible that the communication between the mobile station and base transceiver stations is routed disadvantageously from the point of view of positioning methods, namely, through said repeater stations, thereby adding to the repeater station delays and, hence, the inaccuracy of positioning.

Another problem with mobile-related positioning methods is that the mobile station performs fixed measurements without taking into account the environment or other such parameters. In the present system, the serving BTS is the reference BTS so that its OTD values are compared to the neighboring cells' OTD values. In other words, in mobile station positioning the mobile station measures the signals from three base transceiver stations, for example, as well as the respective radio signal propagation times T1, T2 and T3, and reports the time differences T2-T1 and T3-T1 when T1 is the arrival time of the signal transmitted by the reference BTS against which the other times are compared. If the serving cell is connected to a repeater, the system will determine the mobile station position incorrectly because of the repeater station delay. Because of this disadvantage the OTD values are just estimates for the ‘correct’ propagation time difference values.

An object of the invention is to eliminate the repeater station related disadvantages of the prior art concerning the accuracy of positioning.

The principle of the invention is to use in mobile station positioning a method based on propagation time differences, in which method the objects of the invention are achieved by either identifying the base stations which signal through repeater stations and using as reference base stations such base stations where the signal is transmitted without repeater stations between the mobile station and its base station, or, if only base stations are available which have repeater stations, using in mobile station positioning base stations such that the propagation time of the signals coming to the mobile station through those base stations is taken to be the propagation time of said signals through the air, which propagation time is defined as the propagation time of said signals independent of the repeater station delays of certain repeater stations.

A method according to the invention for positioning a mobile station is characterized by that which is specified in the characterizing part of claim 1. A mobile station according to the invention is characterized by that which is specified in the characterizing part of claim 20. A base station according to the invention for determining the position of a mobile station is characterized by that which is specified in the characterizing part of claim 22. A positioning center according to the invention for determining the position of a mobile station is characterized by that which is specified in the characterizing part of claim 24. A mobile station positioning system according to the invention is characterized by that which is specified in the characterizing part of claim 26. Preferred embodiments of the invention are presented in the dependent claims.

The invention provides a method with which it is possible to improve the accuracy of mobile station positioning as compared with conventional positioning by taking into account the delays caused by the electronic processing of the signal in repeaters, i.e. repeater station delays. In this method, the information about those base stations in the coverage area of a mobile station in a mobile communication network that use repeaters is delivered to the mobile station and/or an element in the mobile communication system that carries out positioning, to be used by it. Moreover, in some embodiments according to the invention it is maintained a database of base stations using repeaters in the coverage areas of mobile stations and of the delays produced in the signal processing of these repeaters, to be used for the purposes of propagation time difference based positioning. Elements of a system according to an embodiment of the invention include means for communicating information about the delays associated with positioning as well as memory means for maintaining information concerning the delays for entities that need such information.

The invention brings advantage in positioning accuracy so that, for example, help can be dispatched more quickly to people in distress. Calculation in the mobile communication network is preferably performed by a location service center. In some applications, calculation may be advantageously distributed between the mobile communication network and mobile station.

Let us consider OTD positioning for example. In OTD positioning the mobile station normally calculates a typical impulse response, determines the time differences of the signals coming from the different base transceiver stations and transmits the time difference values to the service center. If the shape of the impulse response is such that time difference cannot be determined in the mobile station, all impulse response data are transmitted to the service center. If there is little signaling capacity, e.g. due to excessive loading of the mobile communication network, the mobile station is instructed to perform a more detailed analysis of the impulse response. If, in some situation, the computing capacity of the mobile station is not enough to perform the task assigned to it, all or part of the signals measured are transmitted from the mobile station to the mobile communication network to be analyzed. When it is known that the mobile station is located in a place which is difficult from the positioning standpoint, such as in the mountains, for example, the mobile station is advantageously right away instructed to report said signals to the service center as it is likely that the mobile station does not have the capacity required to analyze the impulse response in that place.

In a method according to an embodiment of the invention the reference base stations in the positioning are advantageously such base stations that the radio signal transmitted from said base stations will not travel via a repeater. In that case, the base station chosen as reference base station should be as close to the mobile station as possible in order to achieve the best possible measuring accuracy for the quantities input to the positioning algorithm. In a method according to an embodiment of the present invention the positioning entity receives a report indicating base stations which may be associated with repeater-induced delays in the signal propagation times. If the base station in the serving cell is just that kind of a base station, the estimated next closest base station, whose communication does not involve repeater station delay in the signal propagation times, is chosen as the reference base station. The reference selection criterion could be e.g. the quality of signal reception and/or transmission. In addition, the propagation time values obtained through the new base station and other measured base stations can be compared with each other. In one embodiment of the invention a training sequence is used in the propagation time measurement. In an embodiment of the invention measurement results are transfened using a dummy burst.

Although in the examples of the embodiments of the invention OTD-based positioning methods are given emphasis over other methods, a person skilled in the art can easily, on the basis of that which is disclosed here, apply the invention to TOA and E-OTD (Enhanced OTD) based as well as other positioning methods, too. Other positioning methods refer to other than said methods for positioning a mobile station, in which methods the signal travels through a base station and/or repeater or a corresponding device combination producing in a signal based on electromagnetic wave motion and traveling through air, such as a radio signal, a delay which is caused by some other reason than propagation through a medium. Said delay will result in an inaccuracy of positioning not taken into account by said positioning method, which inaccuracy is compensated for by applications according to embodiments of the invention.

The invention is below described more closely, referring to the preferred embodiments presented as examples and to the accompanying drawings where

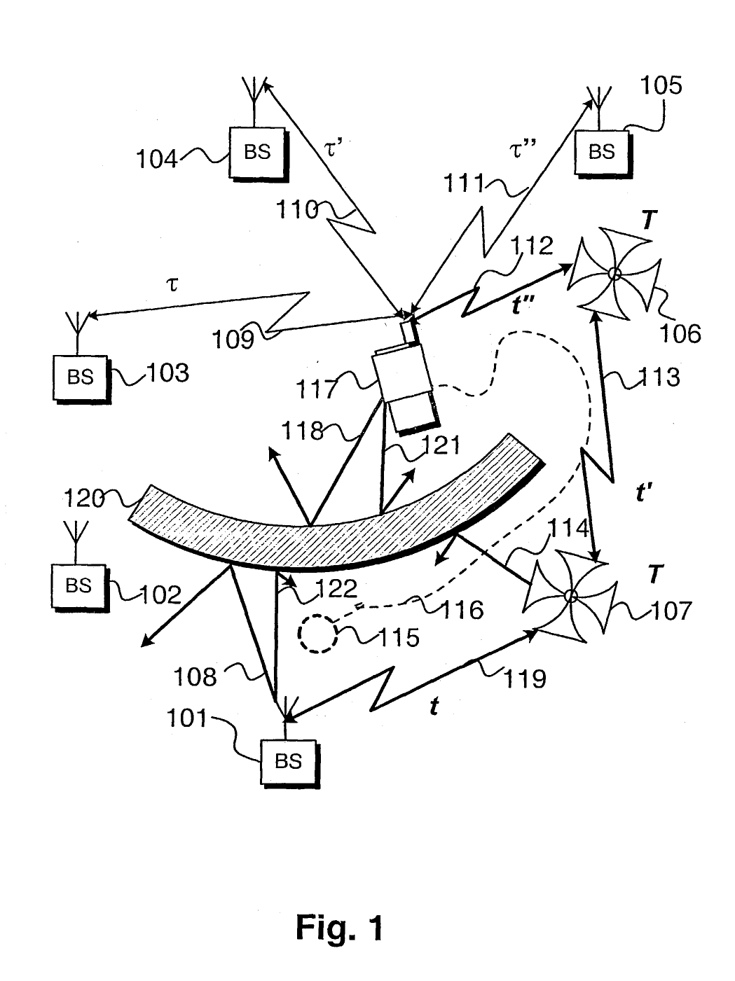

FIG. 1 shows a mobile station, base stations and repeaters in a terrain,

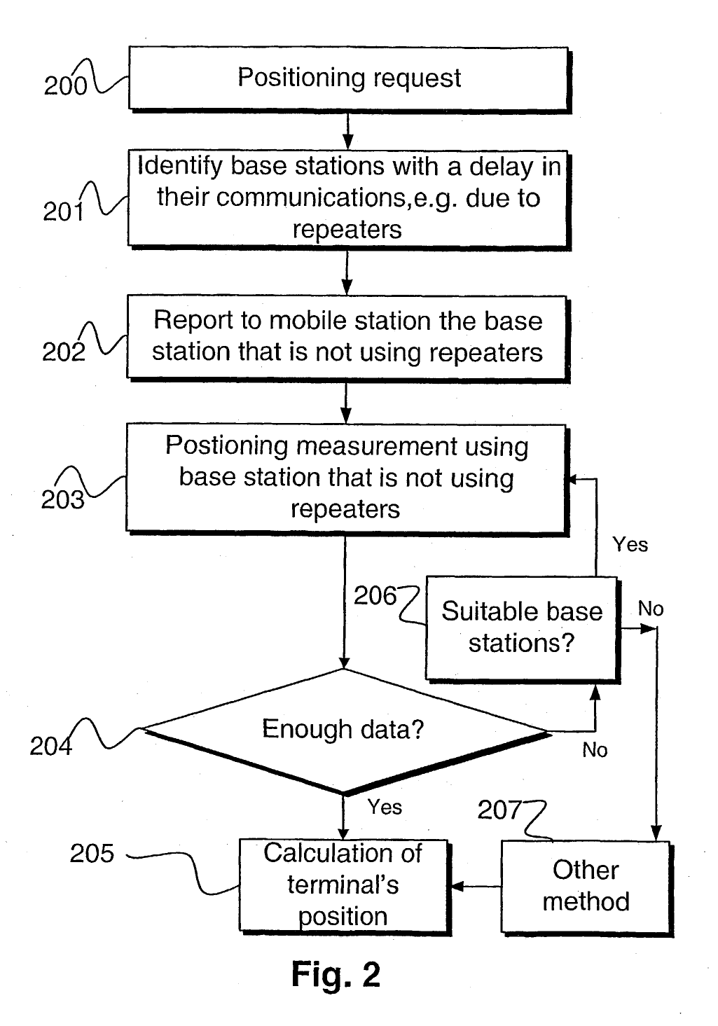

FIG. 2 shows a block diagram of a method according to an embodiment of the invention,

FIG. 2b shows a block diagram of a method according to a second embodiment of the invention,

FIG. 2c shows a block diagram of a method according to a third embodiment of the invention,

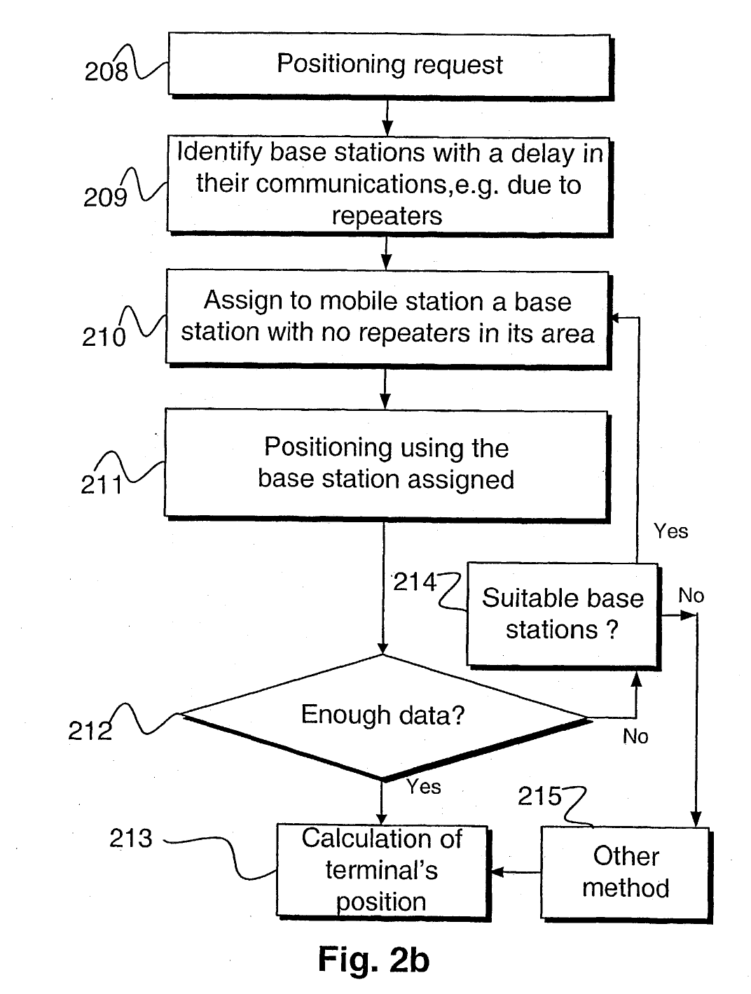

FIG. 3 shows a diagram of a mobile station,

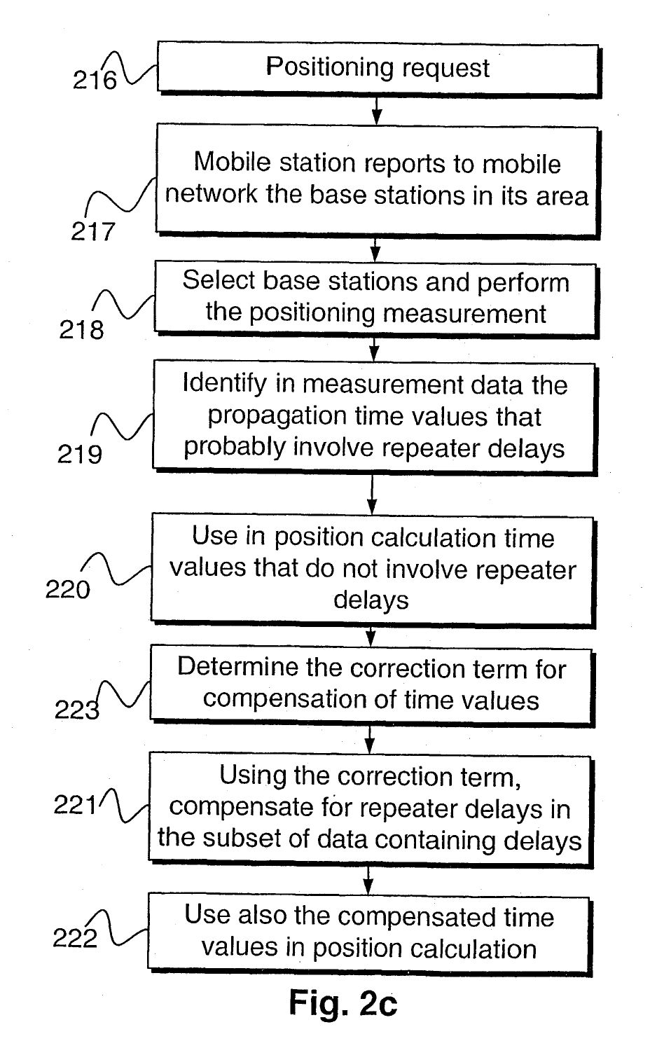

FIG. 4 shows a diagram of a base station,

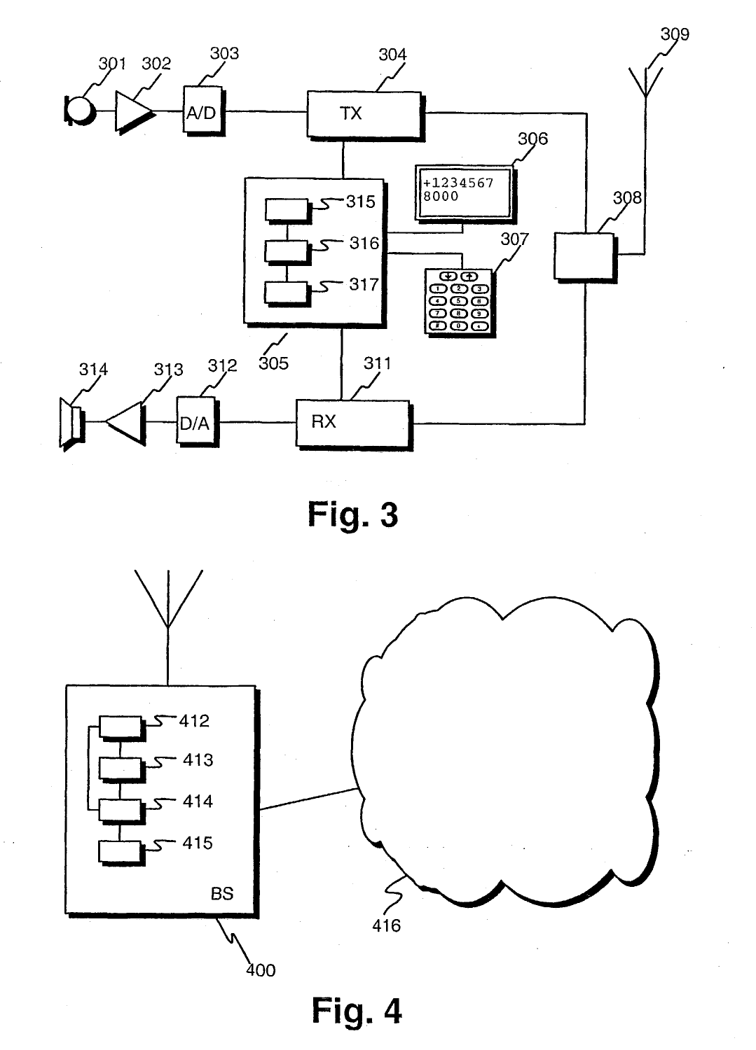

FIG. 5 shows a diagram of a positioning center, and

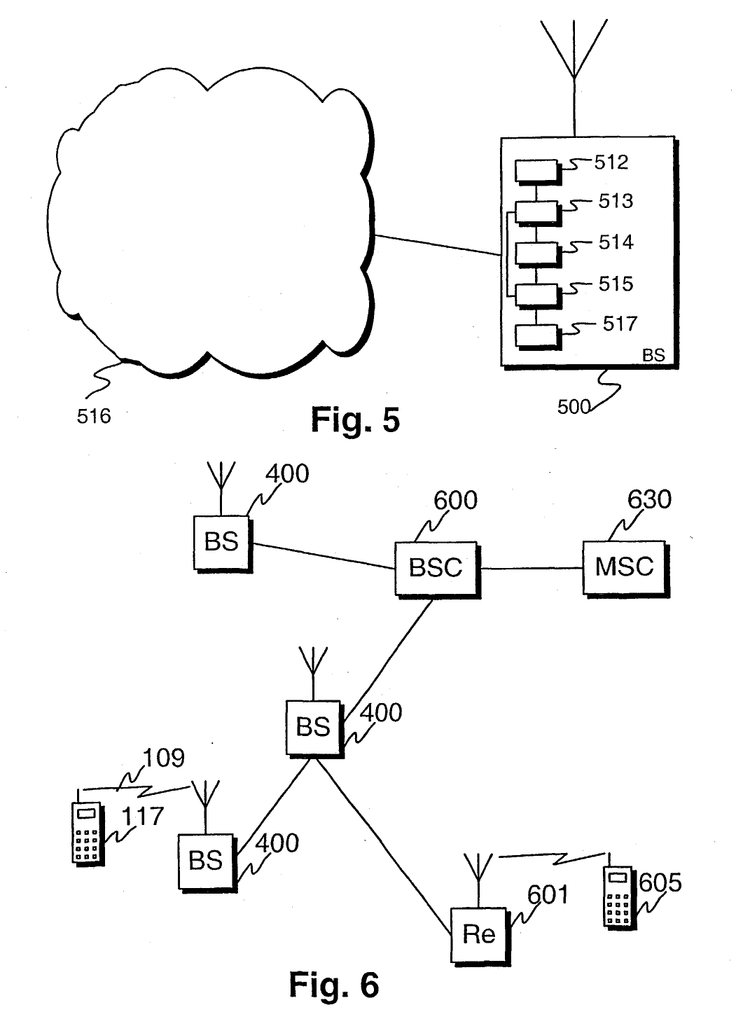

FIG. 6 shows a diagram of a mobile communication system.

Like elements in the figures are denoted by like reference numerals.

FIG. 1 illustrates through the use of an example the problems related to OTD positioning, for instance, caused by a delay which results from signal processing in repeaters 106 and 107 and, on the other hand, signal propagation along its path. In the example of FIG. 1 a mobile station 117 communicates with a base station 101. Initially the mobile station was at point 115 where the signal from base station 101 was the strongest and, therefore, the mobile station 117 selected base station 101 as the serving base station. The mobile station started moving in order to circle an obstacle 120, whereby it still communicates with base station 101 but the signal between the mobile station 117 and base station 101 now passes through repeaters 106 and 107. As this signal is the strongest on the route 116 traveled by the mobile station 117, the latter will not attach itself to base station 103, 104 or 105. When the mobile station has arrived at the end of the route 116, the signal from base station 101 is still the strongest but that is because of the repeater 106. As the radio signal will not penetrate through the obstacle 120, a direct connection between the mobile station 117 and base station 101 is not possible. When the mobile station 117 receives a positioning request, the time differences from the OTD measurement for the signal propagation time from base station to mobile station will be different because of the geometric position of the different base stations and repeaters with respect to one another. Because of the processing related to the reception and transmission of the signal, the repeaters 106 and 107 cause an extra delay Tin the propagation time of the signal for each repeater station, which delay is summed into the propagation time t+t′+t″ proper of the radio signal between the mobile station 117 and base station 101, which propagation time proper is the time used by the radio signal to travel the routes 119, 113 and 112. So, the total propagation time with base station 101 in OTD measurement would be t+t′+t″+T+T when T is the average repeater station delay of the individual repeater stations. The delays are not necessarily equal, but they may be of the same order of magnitude. Depending on the implementation and technology of the electronic circuitry these speeds may be clearly different compared to the propagation time of the radio signal through a medium. Base stations 103, 104 and 105 are situated clearly a shorter distance away from the mobile station 117 than base station 101, measured along routes 112, 113 and 119, which is the distance traveled by the radio signal. Thus signaling in OTD measurement will produce values that differ considerably from each other, adding to the inaccuracy of positioning.

In a method according to an embodiment of the invention for positioning a mobile station 117 a serving base station 101 is not selected as reference base station which means that one of those base stations which are in the coverage area of the mobile station in a neighboring cell, is selected as reference. In the example of FIG. 1 such base stations are 103, 104 and 105. The number of suitable base stations may vary a great deal from case to case, depending on the location of the mobile station and type of the location area. According to an embodiment of the invention the mobile communication network has information about base stations (101) which communicate via a repeater in some part of their coverage area. In that case, the mobile station receives information about the base stations (103, 104 and 105) which are available for positioning without repeaters involved. By measuring the time differences of such stations with respect to the base station selected as reference the positioning parameters can be determined with an accuracy clearly better than in the prior art, also in the example case illustrated in FIG. 1.

FIG. 2 shows a diagram of a method according to an embodiment of the invention for positioning a mobile station, which method is based on the propagation time difference. When the position of a mobile station or the like is to be determined as a consequence of a positioning request 200, the positioning starts with the identification 201 of base stations which have repeaters on the paths of their signals. At the same time also those base stations are identified that do not involve repeater station delay in their signals.

The identification may be based e.g. on a code to which repeaters add their own processing delay in the corresponding code identifying part when the signal passes through the repeater. Another possible implementation is to utilize a database in order to keep record of repeaters, as well as their delays, operating in the vicinity of base stations in certain areas to be used in propagation time difference based positioning. Where applicable, these data could be owned by the mobile communication network and/or mobile station. For practical reasons it is advantageous that the mobile station has got information about the neighboring cells which have a repeater in their coverage area. Preferably the mobile station also has got information about all those base stations which have a repeater in their coverage area and which in addition to the neighboring base stations are within the reach of the signal of the mobile station. In an area where there are a lot of base stations it suffices that it is known a suitable predetermined number of suitable base stations which are possible base stations to be used in positioning. More complete information about the base stations and their connections to the repeater could be located e.g. in positioning centers from where such information is distributed to the rest of the mobile communication network according to need. In an advantageous embodiment of the invention the mobile station is told 202 the necessary number of potential neighboring base stations and the information on them that is essential from the propagation time difference based positioning standpoint. A third method of implementation is to use only the base stations of the neighboring cells in the positioning and to leave out the serving cell's base station with its possible repeaters in the positioning process. When the mobile station has received the information about a base station that can be used in positioning, it performs 203 the positioning. The mobile station and/or mobile communication network checks 204 if there is enough measurement data for the positioning. If there is, the position of the mobile station is calculated 205 on the basis of the measured data either in a decentralized and/or centralized manner in elements belonging to the mobile communication network.

If the data measured by the mobile station are insufficient for positioning, it is checked 206 if there is a suitable base station available, in the coverage area of which there is no repeater. If a suitable base station is found, it is selected as the next base station with which a propagation time measurement will be carried out 203. The data measured with this base station is used in support of the existing data to calculate the position of the mobile station. If the mobile station does not find a base station with no repeater in the coverage area thereof, it selects a base station which does have a repeater in its coverage area and which thus has an average repeater delay T, which naturally will be reflected in the positioning accuracy. If no suitable base stations are available at the time of positioning, the position is estimated in some other manner, on the basis of the existing data or information given by the last used base station (other method 207).

FIG. 2b shows a diagram of a method according to a second embodiment of the invention for positioning a mobile station, which method is based on propagation time difference. When the position of a mobile station or the like is to be determined as a consequence of a positioning request 208, the positioning starts with the identification 209 of base stations which have repeaters on the paths of their signals. At the same time also those base stations are identified that do not involve repeater station delay in their signals. The method is otherwise similar to the embodiment represented by the block diagram shown in FIG. 2, but differs in that the mobile station is instructed 210 by means of a signal transmitted by the network to use a certain base station. Selection of base stations may be based on the quality of the signal between the base station and mobile station, estimated base station location relative to the mobile station, or some other factor relevant to the communication between the base station and mobile station. In that case a database in the network contains information about base stations in the coverage area and repeaters operating in connection therewith. When the mobile station has received the information about a base station that can be used in positioning, it performs 211 the positioning The mobile station and/or mobile communication network checks 212 if there is enough measurement data for the positioning. If there is, the position of the mobile station is calculated 213 on the basis of the measured data either in a decentralized and/or centralized manner in elements belonging to the mobile communication network.

If the data measured by the mobile station are insufficient for positioning, it is checked 214 if there is a suitable base station available, in the coverage area of which there is no repeater. If a suitable base station is found, it is selected as the next base station with which a propagation time measurement will be carried out 211. The data measured with this base station is used in support of the existing data to calculate the position of the mobile station. If the mobile station does not find a base station with no repeater in the coverage area thereof, it selects a base station which does have a repeater in its coverage area and which thus has an average repeater delay T, which naturally will be reflected in the positioning accuracy. If no suitable base stations are available at the time of positioning, the position is estimated in some other manner, on the basis of the existing data or information given by the last used base station (other method 215).

When calculation of position is the responsibility of the mobile communication network, it is advantageous to indicate to the mobile station all base stations in the coverage area, whereafter it is determined on the basis of the response observed by the mobile station, which propagation time values are values compared to base stations and which are values compared to repeaters. When this has been done, it is possible to either remove the values involving repeaters from the measurement data or compensate for the repeater-induced delays in said measurement data.

FIG. 2c shows a diagram of a method according to a third embodiment of the invention for positioning a mobile station, which method is based on propagation time difference. The positioning begins with a positioning request 216. The mobile station then reports 217 to the mobile network all the base stations in its coverage area. The mobile station and mobile network perform 218 a decentralized or centralized OTD measurement using base stations selected according to a certain criterion. From the resulting data it is identified 219 the signal propagation time values which may include repeater-induced delays. On the basis of the identification the position calculation uses 220 the values that do not include repeater delays. In addition, that part of the data, which was identified to include repeater delays, and/or information in the databases is used to determine 223 a correction term to compensate for the delays caused by repeaters. The correction term is used to compensate 221 for the repeater delays. The compensated data are used 222 in the calculation of position. Compensation and identification can be realized either serially according as the time value identification progresses or as a separate stage in which all the values requiring compensation are corrected. FIG. 2c shows only an exemplary order for a method according to an embodiment of the invention without restricting the invention to any certain order of steps.

FIG. 3 shows a block diagram of a mobile station according to an exemplary embodiment of the invention. The mobile station comprises parts typical of the apparatus, such as a microphone 301, keypad 307, display 306, earphone 314, transmission/reception switch 308, antenna 309 and a control unit 305. In addition, the figure shows transmission and reception blocks 304, 311 typical of a mobile station.

The transmission block 311 comprises functions related to the speech encoding, channel encoding, encryption and modulation as well as the RF functions. The reception block comprises the corresponding RF functions as well as functions required for the demodulation, decryption, channel decoding and speech decoding. A signal coming from the microphone 301, amplified in the amplifier stage 302 and converted digital in an A/D converter, is taken to the transmitter block 304, typically to a speech encoding element in the transmitter block. A signal shaped, modulated and amplified by the transmitter block is taken via the transmission-reception switch 308 to the antenna 309. A signal to be received is brought from the antenna via the transmission/reception switch 308 to the receiver block 311 which demodulates, decrypts and channel-decodes the received signal. The resulting speech signal is taken via a D/A converter 312 to an amplifier 313 and further to the earphone 314. The control unit 305 controls the operation of the mobile station, reads control commands given by the user on the keypad 307 and sends messages to the user by means of the display 306. In addition the mobile station comprises means 315 for performing propagation time difference measurements. The means are preferably implemented as software, just as the means 316 in the mobile station to identify base stations. Moreover, the mobile station comprises memory means 317 for storing propagation time difference measurement data and identification parameters for positioning purposes.

FIG. 4 shows a block diagram of a base station 400 comprising signaling means 412 for signaling with a mobile communication network 416 and means 413 according to an embodiment of the invention for performing propagation time difference measurements. The means are preferably implemented as software, just as the means 414 in the base station to identify base stations that do not use repeaters. Moreover, the base station 400 comprises memory means 415 for storing propagation time difference measurement data and identification parameters for positioning purposes.

FIG. 5 shows a positioning center 500 comprising signaling means 512 for signaling with a mobile communication network 516 and means 513 according to an embodiment of the invention for performing propagation time difference measurements. The means are preferably implemented as software, just as the means 514 in a base station to identify base stations that do not use repeaters. Moreover, the base station 500 comprises memory means 515 for storing propagation time difference measurement data and identification parameters for positioning purposes. In addition, a positioning center according to an embodiment of the invention comprises means 517 for maintaining databases of base stations.

FIG. 6 shows a system according to an embodiment of the invention with at least one mobile station 117, base station 400 and a repeater 601 as well as a positioning center, which comprise means for performing propagation time difference measurements, processing measurement data, transmitting the data on a radio path through transceivers, and memory and database means for saving propagation time difference data and/or position information to be used by system components which take part in the positioning. The positioning can be realized in a decentralized and/or centralized manner so that positioning related routines are divided among the mobile station and mobile network according to preset criteria associated with the data. The positioning center may be located in connection with a base station 400 or in connection with a special controller base station 600 controlling the operation of multiple base stations, as in FIG. 6.

Moreover, in some advantageous embodiments of the invention, signal propagation time values obtained from base stations that do not have repeaters in their coverage areas and those obtained from base stations that do have repeaters in their coverage areas, are compared with each other. On the basis of the magnitudes of the propagation time values it is then possible to estimate and model the effect of the presence of repeaters on the propagation time. In addition, observed propagation times can be used to determine the mathematical relation between the ‘correct propagation time’ (propagation time through air) and the propagation time affected by a repeater, using material accumulated during the use of the method according to the invention, whereby it is possible to estimate propagation times more efficiently and thus reduce positioning inaccuracy. Said mathematical relation is called correlation. In correlation, there is preferably time and place dependency between the real propagation time and observed propagation time as well as loading and transmission power dependencies for base stations and repeaters so that mathematical modeling and database use will give a more accurate idea of the propagation time values that would be expected of signals arriving from a given base station.

Applications according to advantageous embodiments of the invention where information is communicated between a mobile station and base station, may employ a dummy burst for communicating data or data elements, which dummy burst is transmitted when no other data proper are transmitted through the air interface.

In some advantageous embodiments of the invention the base stations which are used are such that the communication with them does not involve signaling via repeater stations between the base station and mobile station. It is, however, likely that base stations must be used which do employ repeaters for communicating with the mobile station the position of which is to be determined. In that case, in an advantageous embodiment of the invention at least one base station for the positioning is chosen such that it communicates with said mobile station without a repeater, whereby the propagation time values obtained with said base station are independent of the values obtained by means of other base stations. Moreover, it is then possible to estimate repeater delays and make the corresponding corrections in the signal propagation times in order to improve the positioning accuracy.

Let it be reminded that the principle of the invention is also applicable to other than OTD-based positioning methods, i.e. methods in which the propagation time of a signal or some other similar quantity is determined in one way or another, which quantity depends, among other things, on the influence of a repeater on a certain characteristic of the signal observed, which characteristic depends on the distance between the base station and mobile station on a scale of the quantity measuring said characteristic. Thus, said quantity and the distance between the mobile station and base station have a certain correlation which can be used to determine the geographical position of the mobile station. Thereby in accordance with an embodiment of the invention it is possible to compensate for the effect of a repeater on the characteristic of the signal. By repeater it is meant an apparatus in which the signal travels in a certain direction, e.g. from base station to mobile station and/or vice versa, so that the repeater does not modify the signal or add to it data originating from the repeater, differing thus from the functions of a mobile station and/or base station, where associated information intended to be used in the interpretation of communication between the base station and mobile network can be added to the signal. Furthermore, by repeater it is also meant an apparatus which reproduces the signal transmitted to it, preferably amplified, but which additionally also measures and/or adds to the signal information about its own delay caused by the functions of said apparatus in the propagation time of the signal.

1. A method for positioning a mobile station with the help of base stations in a cellular radio network, characterized in that in order to position a mobile station, it is used at least one base station (103, 104, 105) such that in the positioning, the propagation time of the signals coming from that base station and/or transmitted to that base station from the mobile station is independent of the repeater station delays of certain repeaters (106, 107).

2. A method according to claim 1 for positioning a mobile station, characterized in that the method comprises steps in which
base stations (101) are identified (209) which involve in addition to the propagation delay of the radio signal a repeater-induced delay in their communication,
a base station is assigned (210) to the mobile station (117) such that the mobile station and base station communicate in the coverage area of said base station without repeaters, and
the base station assigned is used (211) in the positioning.

3. A method according to claim 1 for positioning a mobile station (117), characterized in that the method comprises steps in which
base stations (101) are identified (201) which communicate with the mobile station through a repeater, and/or base stations (103, 104, 105) are identified which communicate with the mobile station without a repeater,
data are sent (202) to the mobile station (117), which data are needed to use the base stations in the coverage area of the mobile station and which data include information about base stations with which the mobile station can communicate without a repeater (106, 107), and
for positioning, the mobile station (117) selects (203) as reference base station a base station (103, 104, 105) with which the mobile station communicates without a repeater (106, 107).

4. A method according to claim 3, characterized in that if there are not enough base stations available for positioning with which the mobile station can communicate without a repeater, then the time delays in the propagation time of the signal carrying said communication, which delays are caused by the electronic processing of said signal in repeaters, are estimated and taken into account in the positioning.

5. A method according to claim 4, characterized in that
the position of the mobile station is determined by means of propagation time difference measurement using a base station as reference base station,
the position of the mobile station is determined by means of propagation time difference measurement using a second base station as reference base station,
the propagation times obtained from the propagation time difference measurements are compared to one another in order to determine a propagation time correction term for the repeater delay.

6. A method according to claim 3, characterized in that the base stations for the positioning are selected on the basis of characteristics of the signal transferred between the base station and mobile station.

7. A method according to claim 3, characterized in that a base station for the positioning is selected on the basis of its estimated location.

8. A method according to claim 1 for positioning a mobile station, characterized in that the method comprises steps in which
the mobile station reports (217) to the mobile network the base stations in its coverage area,
base stations suitable for positioning are selected (218),
positioning measurement is performed (218) with the base stations selected in order to produce measurement data,
from the measurement data is identified (219) the propagation time values which are likely to contain repeater delays,
a correction term is determined (223) to compensate for the repeater delays,
repeater delays are compensated (221) for in the subset of data containing such delays, and
the position coordinates are calculated.

9. A method according to claim 8, characterized in that said correction term is recorded in a database.

10. A method according to claim 9, characterized in that said correction term is delivered from the database to a mobile station.

11. A method according to claim 9, characterized in that said correction term is delivered from a database to be used in the positioning of other mobile stations in the coverage area of said base station.

12. A method according to claim 9, characterized in that based on the values in a database a correlation is formed between the observed propagation time values and propagation time values of propagation through air.

13. A method according to claim 12, characterized in that the correlation involves place dependency.

14. A method according to claim 12, characterized in that the correlation involves time dependency.

15. A method according to claim 12, characterized in that the correlation involves dependency on base station load.

16. A method according to claim 12, characterized in that the correlation involves dependency on repeater station load.

17. A method according to claim 12, characterized in that the correlation involves dependency on the transmission power of the communicating stations.

18. A method according to claim 1, characterized in that in the method it is measured the propagation time of a radio signal and the measurement results are transmitted in a dummy burst.

19. A method according to claim 1, characterized in that in the method it is measured the propagation time of a radio signal between a mobile station and a first base station, and between the mobile station and a second base station in order to obtain a propagation time difference, and a training sequence is used in the measurement of the propagation times.

20. A mobile station, characterized in that the mobile station comprises:
means for performing propagation time difference measurements,
transceiver means for transferring positioning data between the mobile station and mobile communication network, and
means for identifying base stations the signals of which have arrived at the mobile station via a repeater and/or for identifying base stations the signals of which have arrived at the mobile station without repeater involvement.

21. A mobile station according to claim 20, characterized in that it comprises memory means for storing propagation time difference measurement data and identification parameters.

22. A base station in a mobile communication network for determining the position of a mobile station, characterized in that said base station comprises
means for performing propagation time difference measurements,
transceiver means for transferring positioning data between the mobile station and mobile communication network, and
means for identifying base stations which communicate with the mobile station through a repeater and/or for identifying base stations which communicate with the mobile station without repeater involvement.

23. A base station according to claim 22, characterized in that it comprises memory means for storing propagation time difference measurement data and identification parameters.

24. A positioning center for determining the position of a mobile station, characterized in that said positioning center comprises
means for processing propagation time difference measurement data,
transceiver means for transferring positioning data via a mobile communication network to a mobile station and, and
means for identifying base stations with which the mobile station communicates through a repeater and/or for identifying base stations with which the mobile station communicates without repeater involvement.

25. A positioning center according to claim 24, characterized in that it comprises memory means for storing propagation time difference measurement data and identification parameters as well as memory means for maintaining positioning databases.

26. A mobile station positioning system with at least one mobile station, base station and positioning center, characterized in that it comprises the following means:
means for performing propagation time difference measurements,
means for processing propagation time difference measurement data,
transceiver means for transferring positioning data between the mobile station and mobile communication network,
means for identifying base stations the signals of which have arrived at the mobile station via a repeater and/or for identifying base stations the signals of which have arrived at the mobile station without repeater involvement,
memory means for storing propagation time difference measurement data and identification parameters, and
memory means for maintaining positioning databases.

27. A system according to claim 26, characterized in that it comprises a repeater for conveying communication between a mobile station and base station.

28. A repeater according to claim 27, characterized in that it comprises means for determining a repeater delay.

29. A repeater according to claim 27, characterized in that it comprises means for attaching information about a repeater delay to be conveyed by a signal between a base station and mobile station.

30. A repeater according to claim 27, characterized in that it comprises means for conveying information about a repeater delay to a mobile communication network.
